(19) United States
(12) Patent Application Publication
(10) Pub. No.: US 2002/0116451 A1
(43) Pub. Date: Aug. 22, 2002

(54) Method and apparatus of providing a link between artists, retailers, and fans

(76) Inventor: Todd J. Souvignier, San Mateo, CA (US)

Correspondence Address: Judith Szepesi, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/834,553

(22) Filed: Apr. 12, 2001

Related U.S. Application Data
(60) Provisional application No. 60/212,702, filed on Jun. 19, 2000.

(51) Int. Cl. G06F 15/16

(52) U.S. Cl. 709/203; 709/218

(57) ABSTRACT

A method and apparatus for providing a link between artists/labels/retailers and fans is provided.

### REFERENCE TO RELATED APPLICATION

This application claims the benefit of U.S. Provisional Application No. 60/212,702 filed Jun. 19, 2000.

### FIELD OF THE INVENTION

The present invention relates to the Internet, and more specifically, to making content available on a user's system.

### BACKGROUND

Most people purchase their music in compact disk or similar form. However, music is becoming available over the Internet. People are able to download music, and listen to it on their home computers.

Fans can further find information about their favorite artists on the Internet. Artists often make additional data, video, and photos available on web sites. Furthermore, data such as concert schedules may also be made available on a web site. However, a fan must pro-actively seek out such a web site. Generally, this involves using a search engine, which may return hundreds or even thousands of hits. Furthermore, if the artist's name is a common term, this may be even more difficult. The fan must then wade through all of these sites to identify the site of interest. At that point, the fan is still not able to determine whether the site is the “official site” of the artist, a fan site, or possibly a negative site. Therefore, data found on such a site cannot be trusted.

### SUMMARY OF THE INVENTION

A method and apparatus for providing a link between artists/labels/retailers and fans is provided.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of one embodiment of a network.

FIG. 2 is a block diagram of one embodiment of a computer system.

FIG. 3 is a block diagram of the system, including a client portion and a server portion.

FIGS. 4A and 4B are block diagrams of embodiments of a database layout.

FIG. 5 is a flowchart of one embodiment of the use process, from the user's perspective.

FIG. 6 is a flowchart of one embodiment of the use process, from the server's perspective.

FIG. 7 is a flowchart of one embodiment of the administrative tool use.

FIG. 8 illustrates one embodiment of the user interface.

FIGS. 9A, 9B, and 10 illustrate one embodiment of the selection logic interface.

FIG. 11 illustrates one embodiment of the administration interface.

FIG. 12 is a flowchart of one embodiment of using the artist/user interface from a user's perspective.

FIG. 13 is a flowchart of one embodiment of using the artist/user interface from the server's perspective.

### DETAILED DESCRIPTION

A method and apparatus for providing content to a user's system is described. The software manages the multitude of digital distribution formats available, including MP3, Windows Media, WAV and over a dozen others. All a user has to do is drag music selections into the software, hit the burn button, choose a destination device (like the Diamond RIO or a CD-R drive) and the software does the ripping, unlocking, and transcoding. This means users don't have to be aware of the distinction between a Liquid Audio file and an MP3 file, freeing them to locate and purchase as many different types of music files as they wish without benefit of any technical knowledge.

Locating files on the Web is another challenge solved with the software application. Autobot asks the user questions about his or her musical taste, from general criteria like “I like Rock and Hip Hop” to more emotional questions like, “I like angry women who have an agenda.” The Autobot then delivers music links and graphics to the user's desktop where he or she can preview, buy, download, and burn files. If the amount of files burdens the user's hard drive, the

software allows the user to send all of those files to a 250 MB “online locker” through an arrangement with Myplay.com.

Categorizing such musical selections is done using the administration tool. Using this tool, a set of musical selections is categorized as a group, and a slide show corresponding to the musical set is available. When the user selects the appropriate category, in which this set falls, the data is uploaded to the user. For one embodiment, the data is fed, one slide/selection at a time.

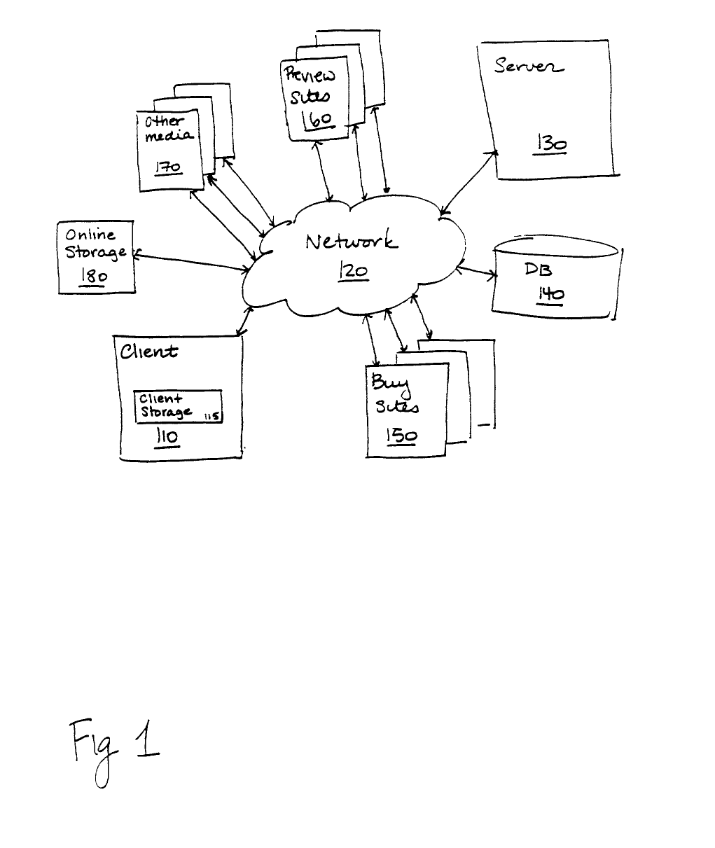

FIG. 1 is a block diagram of one embodiment of a network. A client 110 is coupled to the network. The client 110 may be a computer system, such as a user's home computer system. The client 110 includes the client portion of the software. The client 110, for one embodiment, further includes client storage 115, for storing data obtained through the network 120.

The network 120, for one embodiment, may be the Internet. For another embodiment, the network 120 may be a local area network (LAN), wide area network (WAN), or another type of network that permits client 110 to be coupled to server 130.

Server 130 may be a separate computer from client 110, or may be the same computer. Server 130 includes the server portion of the software. Server is also coupled to network 120, and, for one embodiment, client 110 accesses server 130 through a network.

Server 130 may include database 140. For another embodiment, database 140 may be a distributed database. For yet another embodiment, database 140 and server 130 may both be distributed. Such implementations are known in the art.

Database 140 includes a plurality of data entries. For one embodiment, at least some of the data entries include pointers—links—to buy sites 150, preview sites 160, and/or other media sits 170, as will be explained below. The user acquires data from database 140, through server 130. When the user makes a particular selection, the user may be coupled to preview site 160, buy site 150, or other media site 170, depending on user's selection.

For one embodiment, the user may additionally have accessible online storage 180. Online storage 180 permits the user to store data acquired from database 140 and/or the other sites 150, 160, 170. This makes data available when user is not at the client system 110. Alternatively, user may store the data in client storage 115, on client system 110.

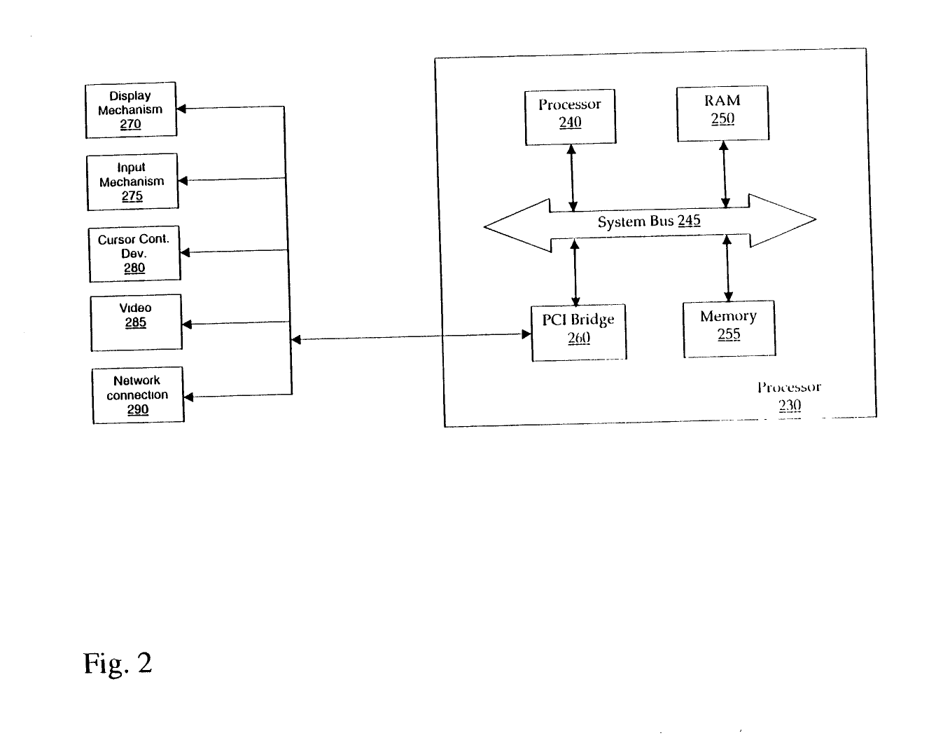

FIG. 2 is one embodiment of computer system on which the present invention may be implemented. It will be apparent to those of ordinary skill in the art, however that other alternative systems of various system architectures may also be used.

The system illustrated in FIG. 2 includes a bus or other internal communication means 245 for communicating information, and a processor 240 coupled to the bus 245 for processing information. The system further comprises a random access memory (RAM) or other volatile storage device 250 (referred to as memory), coupled to bus 245 for storing information and instructions to be executed by processor 240. Main memory 250 also may be used for storing temporary variables or other intermediate information during execution of instructions by processor 240. The system also comprises a read only memory (ROM) and/or static storage device 220 coupled to bus 240 for storing static information and instructions for processor 240, and a data storage device 225 such as a magnetic disk or optical disk and its corresponding disk drive. Data storage device 225 is coupled to bus 245 for storing information and instructions.

The system may further be coupled to a display device 270, such as a cathode ray tube (CRT) or a liquid crystal display (LCD) coupled to bus 245 through bus 265 for displaying information to a computer user. An alphanumeric input device 275, including alphanumeric and other keys, may also be coupled to bus 245 through bus 265 for communicating information and command selections to processor 240. An additional user input device is cursor control device 280, such as a mouse, a trackball, stylus, or cursor direction keys coupled to bus 245 through bus 265 for communicating direction information and command selections to processor 240, and for controlling cursor movement on display device 270. Another device that may optionally be coupled to bus 245 thorough bus 265 is a communication device 290 for accessing other nodes of a distributed system via a network. The communication device 290 may include any of a number of commercially available networking peripheral devices such as those used for coupling to an Ethernet, token ring, Internet, or wide area network. Note that any or all of the components of this system illustrated in FIG. 2 and associated hardware may be used in various embodiments of the present invention.

It will be appreciated by those of ordinary skill in the art that any configuration of the system may be used for various purposes according to the particular implementation. The control logic or software implementing the present invention can be stored in main memory 250, mass storage device 225, or other storage medium locally or remotely accessible to processor 240. Other storage media may include floppy disks, memory cards, flash memory, or CD-ROM drives. It will be apparent to those of ordinary skill in the art that the methods and processes described herein can be implemented as software stored in main memory 250 or read only memory 220 and executed by processor 240. This control logic or software may also be resident on an article of manufacture comprising a computer readable medium having computer readable program code embodied therein and being readable by the mass storage device 225 and for causing the processor 240 to operate in accordance with the methods and teachings herein.

The software of the present invention may also be embodied in a handheld or portable device containing a subset of the computer hardware components described above. For example, the handheld device may be configured to contain only the bus 245, the processor 240, and memory 250 and/or 225. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

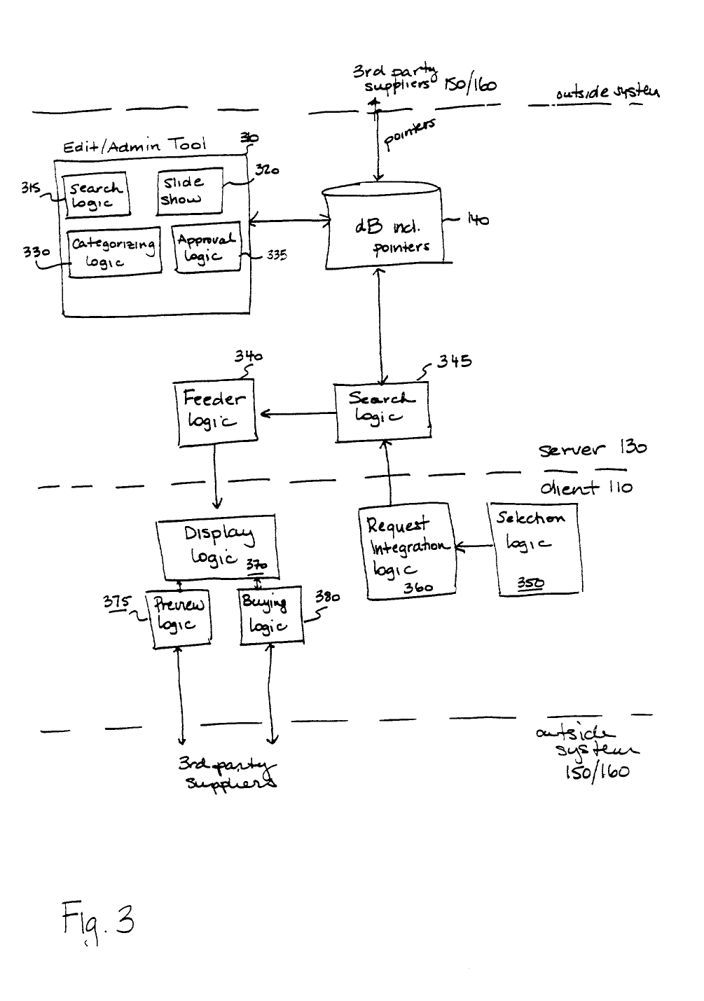

FIG. 3 is a block diagram of the system, including a client portion and a server portion. The system includes the server portion 130 and client portion 110 of the system. For one embodiment, the server portion 130 and client portion 110 may be located on the same computer system. Alternatively, the server portion 130 and client portion 110 may be coupled through a network, such as the Internet, or a wireless network. For reference, portions outside the system are also illustrated.

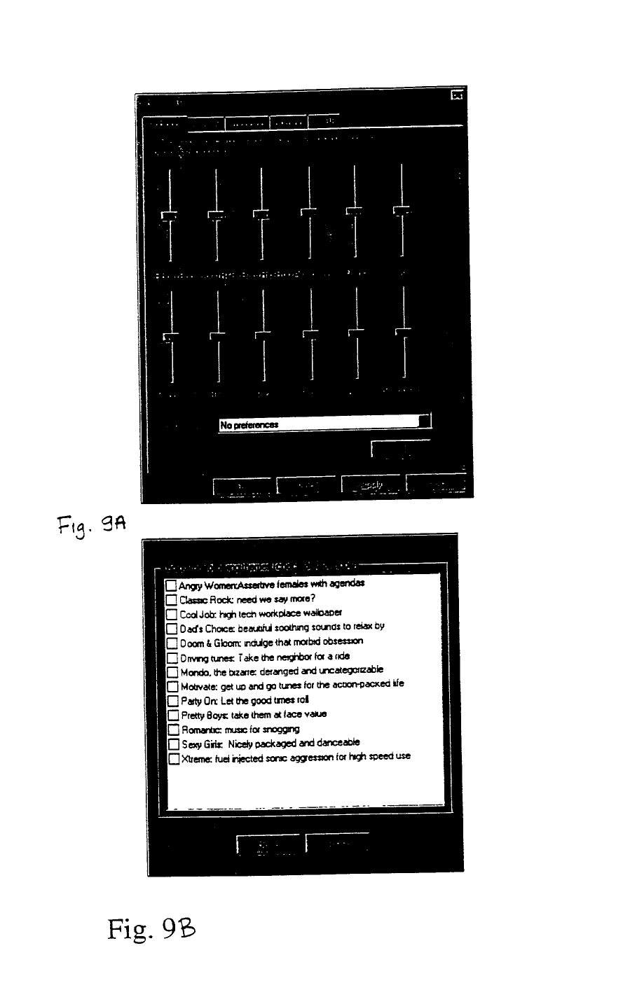

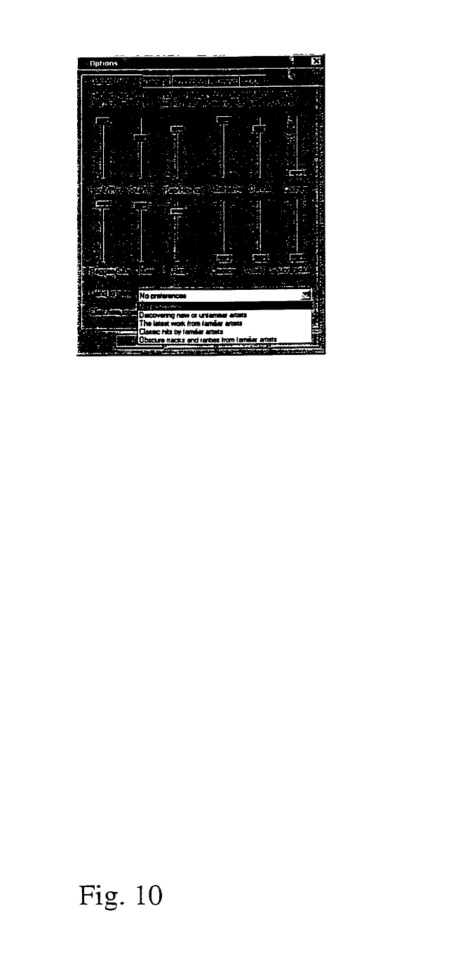

The client portion 110 of the system includes a selection logic 350. Selection logic 350 permits a user to select his or her preferences for musical listening. FIGS. 9A, 9B, and 10 illustrate one user interface which may be used by the selection logic 350. As can be seen from FIGS. 9A, 9B, and 10, the selections may include sliders to select genres, radio buttons to select themes, and a selection from a menu to identify category. It is to be understood that the selection mechanism and categories shown in FIGS. 9A, 9B, and 10 are merely exemplary. As discussed above, this mechanism may be used for other than musical selections. Thus, for example, for searching for video data, the categories, genres, and themes are different. In fact, the individual types of selections (e.g. category or genre) may be different as well (e.g. for a search of publications, the selections may be publication type, publication purpose, and author category.) Other selections may be used, as appropriate for the type of data being presented to the user.

Returning to FIG. 3, the selection logic 350 permits the user to make a musical selection (e.g. what he or she wishes to see/listen to.)

The request integration logic 360 generates a request sent to the server 130, based on the user's selection. For one embodiment, the request logic 360 generates a single statement to be sent to the server 130. The statement includes all of the selections made by the user. For one embodiment, the statement further includes the user's IP address. This IP address is used to return data to the user. By sending the IP address with the request, and not storing the IP address anywhere, the user's anonymity can be maintained, while data is being served to the user. The request generated by request integration logic 360 is sent to search logic 345 in server 130.

The search logic 345 uses the request to search database 140, and retrieve appropriate data. This will be described in more detail below. The search logic 345 results are passed to feeder logic 340. Feeder logic 340 uses the IP address included in the request to pass data for display to the client 110. For one embodiment, the feeder logic 340 does not store the IP address, but rather erases it once the connection with the client system 110 is established. For one embodiment, the feeder logic 340 passes the entire data packet to the client 110 at one time, rather than feeding data bits individually.

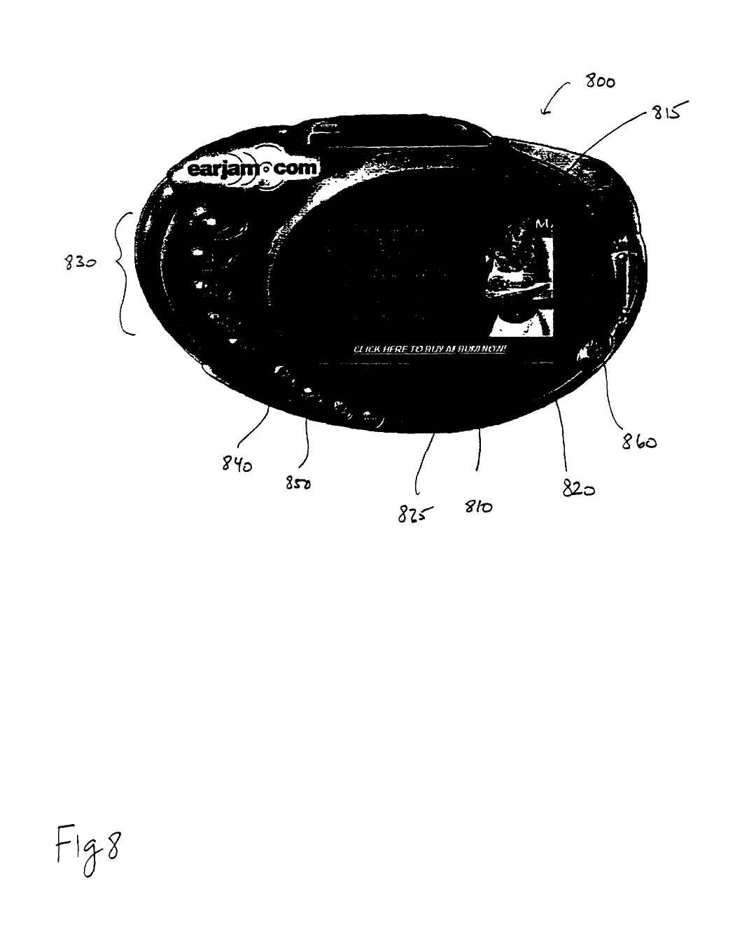

The data is passed by the feeder logic 340 to display logic 370 in the client system 110. FIG. 8 illustrates an exemplary user interface for the client 110, including the display area 810. As can be seen in FIG. 8, the display area 810 includes an album cover 815, or similar image, a list of songs 825, which may be previewed by the user, and a buy-now selection 820, which permits the user to purchase the music.

Preview logic 375 is activated if the user selects the preview option (e.g. double clicks on one of the song lists.) Preview logic 375 connects to an outside partner, based on the pointer associated with the user's selection, and retrieves the media preview requested. As discussed above, this may be an MP3 or other format song preview, or another type of preview.

Buy logic 380 is activated if the user selects the buy option (e.g. clicks on the buy button.) For one embodiment, buy logic 380 opens a new window, to a partner site, permitting the user to purchase the item. For another embodiment, the system may include a shopping logic, permitting the user to purchase the item within the system. Use of such shopping logic is known in the art.

Server 130 further includes editing/administration tool 310. Tool 310 permits administrators and/or certain validated users to add data to the database. For one embodiment, the data added to the database consists of slide sets, e.g. lists of songs that are categorized and that include additional data, and potentially comments.

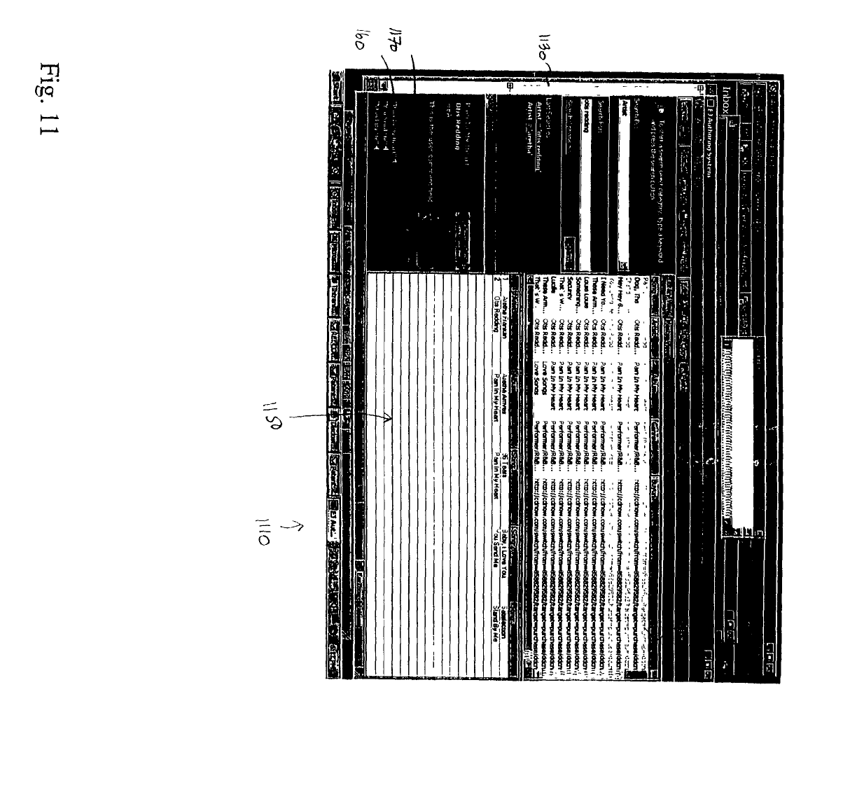

Tool 310 includes a search logic 315, which permits the authorized user to search in the database, or over the Internet. For one embodiment, the search logic 315 may only permit searching for data in the database, or in the databases of affiliates. For another embodiment, search logic 315 may be used to search all of the data on the Internet. For one embodiment, the data retrieved by the search logic 315 is a plurality of song titles, and an appropriate “slide” for each song title. FIG. 11 is an exemplary organization of the user interface of tool 310.

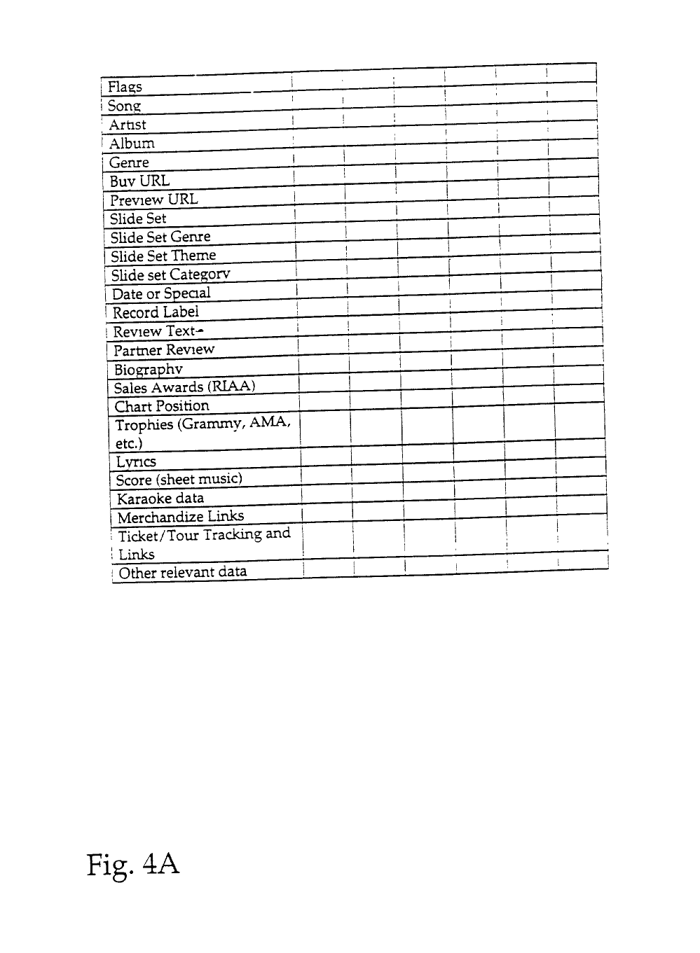

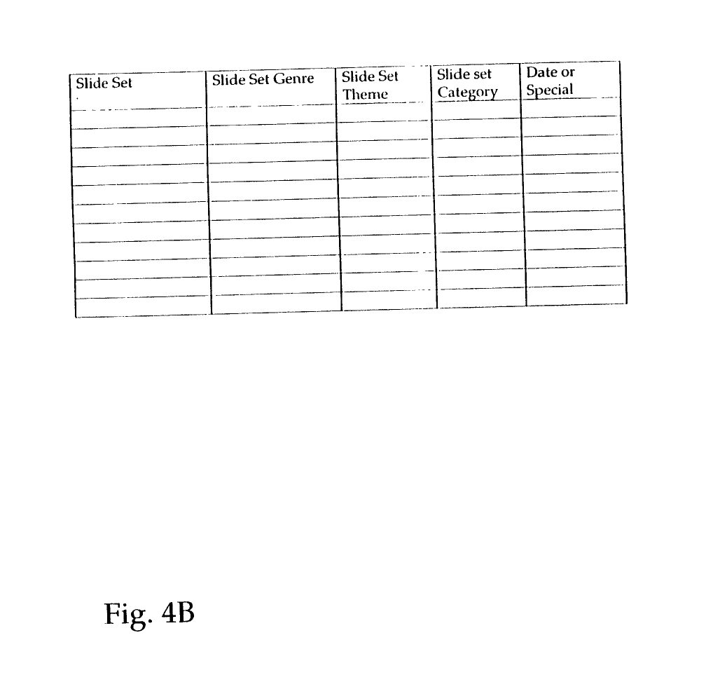

Search area 1130 permits search by various appropriate criteria. Library view 1140 shows the results of the search. For one embodiment, the library view 1140 may be set to show any subset of the data contained in the database about each search result. FIG. 4A illustrates one embodiment of an item that may be retrieved by a search. As can be seen, in addition to the items listed, other data may be available. For one embodiment, the search logic 315 may search by any of the criteria available in the database.

When a user selects a song, or group of songs, for one embodiment by clicking on them in the library view 1140, each song is added to the slide set, shown in set view 1150. Each song further has associated with it a slide, which is shown in the slide view 1160.

Returning to FIG. 3, slide show 320 constructs a slide show that illustrates each of the song selections made by the user.

Categorizing logic 330 permits the user to categorize the slide set, e.g. categorize all of the songs that are a part of the slide set. The categories correspond to the user selection categories discussed above with respect to FIGS. 9A, 9B, and 10.

After the authorized user categorizes the slide set, the data is passed to the approval logic 335. The approval logic 335 permits a supervisor to approve the user's slide set and categorization. When the approval is received by the approval logic 335, the slide set is passed into the database 140, and made available to all users. For another embodiment, if only trusted users are authorized to access the tool 310, the approval logic 335 may not be needed, and after categorization, the slide set may directly be passed to the database 140.

FIG. 4A illustrates one example of the data items that may be in the database about any particular song. As can be seen, the data may include pointers, such as pointers to URLs. For one embodiment, the data may further include pointers for items such as lyrics or images, which may be retrieved on the fly, when the record is accessed by a user. It is to be understood that the list of items are merely exemplary. A subset of the list, or superset of the list, may be used, in the alternative. For other types of data, e.g. not music, other categories may be used, as appropriate.

FIG. 4B illustrates an alternative embodiment of a database. As can be seen, a subset of items are shown. For one embodiment, the slide sets are stored together, e.g. each song/slide data for each item in the slide set is only categorized by the slide set. Thus, the user can retrieve the slide set. For one embodiment, the database structure illustrated in FIG. 4B is used as a search tool, to access the data about all of the songs. In other words, the search process takes place in the index shown in FIG. 4B, while the actual data content is stored in the database illustrated in FIG. 4A.

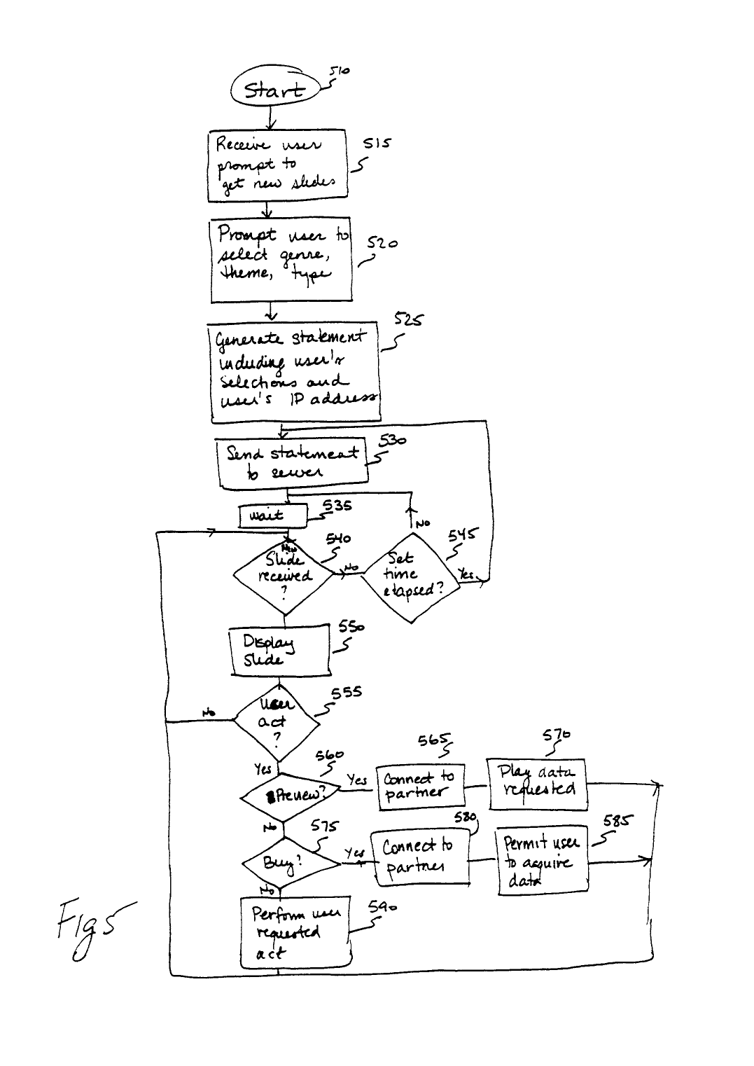

FIG. 5 is a flowchart of one embodiment of the user interaction with the system, from the user's perspective. The process starts at block 510. For one embodiment, prior to this process, the user opens the client portion of the software application. For one embodiment, this system permits complete user anonymity. Therefore, no log-in process is used. An example of the user interface is shown in FIG. 8.

At block 515, a user prompt to get new slides is received by the client system. For one embodiment, the user selects this prompt by clicking on the “data retrieval” button on the user interface.

At block 520, the user is prompted to select genre, theme, type, or whatever appropriate selections are. As discussed above, exemplary interfaces for this selection are shown in FIGS. 9A, 9B, and 10. The user may make selections at each level, or may make selections of only one of the pages. How much or little data the user wishes to supply is entirely up to the user's discretion.

At block 525, a statement is generated, including the user's selections and the user's IP address. For one embodiment, the statement consists of a statement such as a string of <Item><Value>elements. For example, for each item which is selected by a slider bar, the Value may be a number between 1 and 100. For an item which is selected by radio button, the value may be a 1 or a 0. For an item which is selected via a pull-down menu, only a single item may be shown in the statement, indicating via an alphanumeric character what the selection is. Thus, for example, the statement may appear as follows:

RP50SR0RH0A20D50C40RS100B100J75CL50W0S0AN1CR1M1 TA

This statement corresponds to the genres, themes, and type selection shown in FIGS. 9A, 9B, and 10. To this statement, the IP address of the user is attached. This permits the system to respond with data to the user without having any further information about the user, and without requiring a permanent connection.

At block 530, the statement is sent to the server.

At block 535, the system waits for a response from the server. It is to be understood that although the system is waiting, the user may perform other tasks, and use the system for other things.

At block 540, the process determines whether a new slide was received. If a new slide was received, the process continues to block 550. Otherwise, the process continues to block 545. At block 545, the process determines whether a preset time period has expired since the statement was sent to the server. For one embodiment, after a period of time, the system times out. If the preset time period has elapsed, the process returns to block 530, and the statement is resent to the server. If the time period has not elapsed, the process returns to block 535, to continue waiting for the response.

IF the slide was received at block 540, at block 550, the slide is displayed to the user. An image showing the slide display in the user interface is shown in FIG. 8.

At block 555, the process determines whether the user acted, e.g. pressed a key, or otherwise indicated that he or she wishes for something to occur. If the user did not act, and a period of time has elapsed, the process returns to block 540, to wait for the next slide. For one embodiment, the slides cycle every 6 seconds, if the user does not act. For another embodiment, the slides may cycle at a different rate. For one embodiment, the user may set the rate of cycle, anywhere from hours to mere seconds.

If the user did act, at block 555, the process continues to block 560. At block 560, the process determines whether the user selected a preview. A preview permits the user to listen to a musical selection, or otherwise see a relevant data about the choices. For example, for a movie, the preview may be a trailer. If the user selected a preview to listen to, the process continues to block 565.

At block 565, a connection is established from the client system to the partner who is hosting the preview. For one embodiment, the system does not host previews, but rather only has pointers to partners who actually host the previews. This reduces the size of the database considerably, as well as reducing traffic. For another embodiment, the “partner” who whom connection is established may be the same server as that hosting the database.

At block 570, the data requested by the user is obtained from the partner and played. For one embodiment, if the preview is music, streaming audio may be used to transfer the data to the client system. The process then returns to block 540, to wait for the next slide. For one embodiment, the slide does not change while the preview is running. For one embodiment, the slide from which a preview was selected is shown for a period of time after the preview has completed playing.

If the user did not select a preview at block 560, the process continues to block 575. At block 575, the process determines whether the use selected the buy option.

If the user selected the buy option, the process continues to block 580. At block 580, a connection is established to the partner who is making the user's selection available for purchase. At block 585, the user is permitted to acquire the data. For one embodiment, purchase may be a purchase of a compact disc or similar device, a single song, a user-compiled custom compact disc, or another type of purchase. For one embodiment, if a free copy of the song is available, the “purchase” may refer to the free download of the song or songs. For one embodiment, these choices are made on a separate window, which is opened to the partner who is offering the selection. For one embodiment, if multiple partners are offering the selection, the user may be permitted to chose where to obtain the data from. The process then returns to block 540, to wait for the next slide.

If the user's action was another selection, the user requested act is performed at block 590. For example, the user may request more data about the song, or perform other actions. The process then returns to block 540, to await the next slide. For one embodiment, the user may quit out of the system at any time.

In this way, a user can receive a slide show displayed on the user's own computer system. The user can listen to previews of songs or purchase songs. This method further protects the user's privacy, since no cookies or other data storage needs to take place.

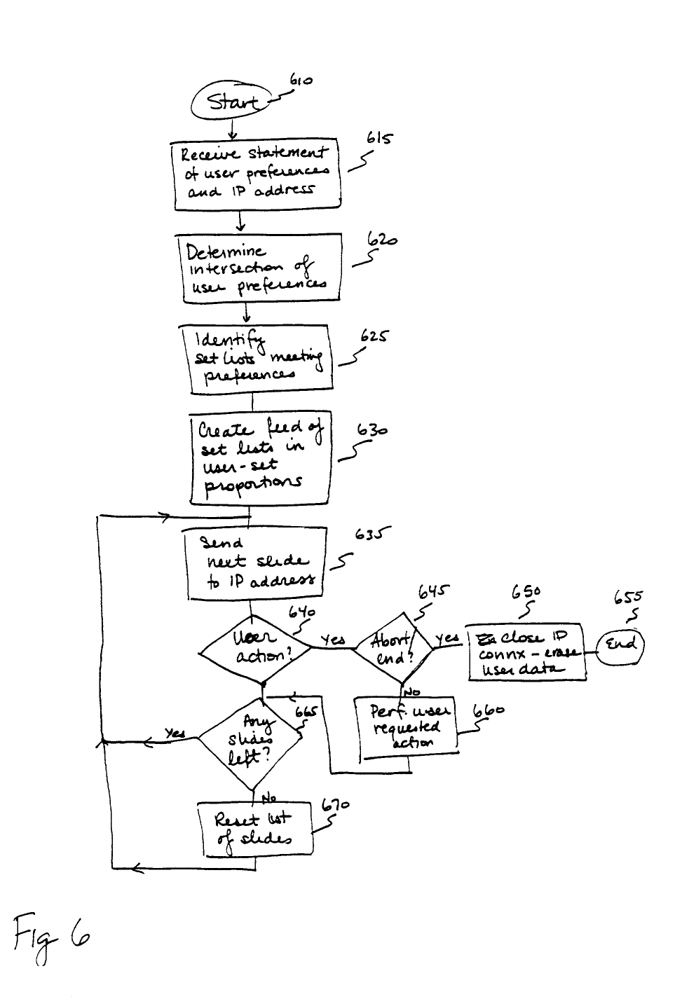

FIG. 6 is a flowchart of one embodiment of the use of the system, from the server's perspective. The process starts at block 610. For one embodiment, multiple such processes may be running at any time. For one embodiment, for each request received, a new process is started, as shown here.

At block 615, a statement is received about the user's preferences, including the user's IP address. As described above with respect to FIG. 5, the statement includes all of the user's preferences and the user's IP address.

At block 620, the intersection of user preferences is determined. For one embodiment, only those slide shows or songs that fit all of the user preferences are shown to the user. Thus, for example, if a user selected as genre 50% Jazz and 50% Classic Rock, the system would present 50% from each category. If the user selected Jazz, and as the theme Driving tunes, the slide show would consist of items that were in the format Jazz that were categorized as driving tunes. Similarly, the third factor, type is factored in.

For another embodiment, genre and theme are individually searched, and the user is passed 50% from the choice genre(s), and 50% from the choice themes. Alternative methods of implementing such a choosing process may be used.

At block 630, a feed is created of the set lists that matched the user's selections. As discussed above, for one embodiment, the individual slides are passed in individual packets to the user. These packets are prepared by at block 630.

At block 635, the next slide in line is sent to the IP address supplied by the user.

At block 640, the process determines whether there was a user action that would alter the feeding process. If there was a user action, the process continues to block 645.

At block 645, the process determines whether the user aborted the display loop. The user may do this by pressing a stop button, or making a new selection, closing the user interface, or another means. If the user selected to abort/end the display loop, the process continues to block 650.

At block 650, the IP connection with the user is closed, and all user data is erased. In this way, user privacy is maintained. The process then ends at block 655.

If the user action was not an abort/end action, the process continues to block 660, and the user requested action is performed. For example, if the user selected a preview, the process may slow down displaying the next slide, e.g. delay sending the next packet of data to the user. The process then returns to block 665. The user may alternatively request additional information about data in a slide. For example, a user may request a complete song list for a particular compact disc. This type of data would be obtained from the server, and sent at this point.

If, at block 640, there was no user action, the process continues directly to block 665.

At block 665, the process determines whether there are any slides left in the slide feed created for the user. If there are slides left, the process returns to block 635, and the next slide is sent. Note that this occurs after the preset period of time.

If there are no more slides left, the process continues to block 670. At block 670, the slide feed is reset, and the first slide is resent to the user, as the process returns to block 635.

Using this process, the server feeds the user requested data to the user, while maintaining user anonymity.

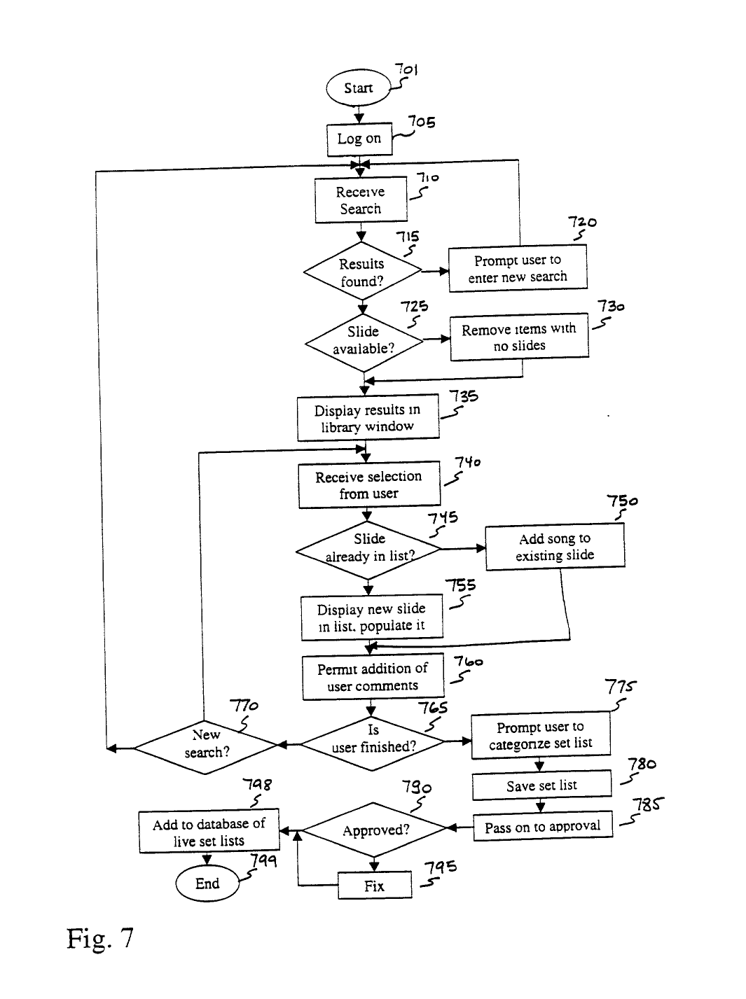

FIG. 7 illustrates one embodiment of the editing/administration process that creates the slide shows that are made available to the user. The process starts at block 701.

At block 705, the user logs on to the system. For one embodiment, the log-on process includes a password/user identification which identifies the level of authorization for the user. For one embodiment, any user may act as an editor for this process. For anther embodiment, only a selected subset of users may act as editors. The log-on process permits access to the editing system for those users who are authorized to perform editing. For one embodiment, this process may include a client-side portion. For another embodiment, the user may directly log into the server, using a network.

At block 710, the system receives a search. The user may enter any search, to find appropriate songs—or other data—to add to the slide show.

At block 715, the process determines whether any results were found. If no results were found, the process continues to block 720, and the user is prompted to enter a new search. If a result was found, the process continues to block 725.

At block 725, the process determines whether a slide is available for each of the search results. If a slide is not available for a search result, that result is removed from the list of results returned to the user, at block 730. For another embodiment, this step may be skipped. However, including this step assures that each of the songs in the slide show has an associated slide.

At block 735, the results—or at least those with a slide—are displayed in the library window. An exemplary user interface for this editing process is shown in FIG. 11.

At block 740, the system receives a user selection. The user may select one or more songs to include in the slide show. For one embodiment, the user selects one song at a time. For one embodiment, if the user does not like the results, he or she may alternatively perform a new search.

When a result is received, at block 745, the process determines whether the slide associated with the selected song is already in the list. For one embodiment, all of the songs on a certain album are associated with the same slide. Thus, if the user has already selected another song from this album, the slide is already in the slide list.

If the slide is already in the slide list, the process continues to block 750, and the song the user selected is added to the existing slide. The process then continues to block 760.

If the slide is not already in the slide list, the process continues to block 755, where the new slide is added to the list, and populated. For one embodiment, each of the elements shown in the slide are pulled from the database. For another embodiment, certain elements may be obtained from third party partners. For example, the image of the CD cover, shown in the slide, may be obtained from a third party, and added to the new slide.

At block 760, the user is permitted to add comments to the slide. The comments may include the user's personal comments, or other data that would be relevant to a client looking at the slide.

At block 765, the process determines whether the user is finished creating the slide list. If the user is not yet finished, the process continues to block 770. At block 770, the process determines whether the user wishes to execute a new search, or add further slides from this search to the slide set. If the user wishes to do a new search, the process continues to block 710, if the user wishes to add further selections from this search, the process continues to block 740.

If the user indicates that he or she is finished with this slide set, the process continues to block 775.

At block 775, the user is prompted to categorize the list. As discussed above, the category choices correspond to the search choices made available to the user. For one embodiment, the user may further be prompted to categorize individual songs, if searching by individual songs instead of slide sets is permitted.

At block 780, the set list is saved. At block 785, the set list is passed to approval. For one embodiment, if certain users who are not trusted users are permitted to edit and create slide shows, an approval process is needed. Alternatively, if only trusted users are permitted to perform editing, the approval process may be eliminated.

At block 790, the process determines whether someone with an approval authority has approved the slide show. For one embodiment, the approval authority reviews the songs in the slide show, the categorization, and any user comments, for appropriateness.

If the slide show is not approved, the process continues to block 795, where it is fixed. For one embodiment, the approval authority performs the fixing. Alternatively, the slide show may be sent back to the user who initially constructed it with comments.

If the slide show is approved, it is added to the database of live set lists, which are available to users, at block 798. The process then ends at block 799.

In this way, editors can create cohesive slide lists that are presented to users. This permits a user to see songs by artists he or she may not be familiar with. For one embodiment, the data of who the editor of the particular slide list is is also made available. Thus, for example, the user may request to see set lists created by an editor who agrees with the users tastes.

FIG. 8 illustrates an exemplary user interface of the client portion of this system. The user interface includes a frame 800 which includes display area 810, showing an exemplary slide with an image 815, song names 825, and a buy option 820. Standard controls 830 are shown in the side. The control to perform the search discussed above is the search button 850. The preview may be selected by selecting a song title 825, and the buy option 820 can also be selected by clicking on it.

For one embodiment, the user interface permits the burning of compact discs using burn button 860. Using this interface, the slide show is shown in the display area 810.

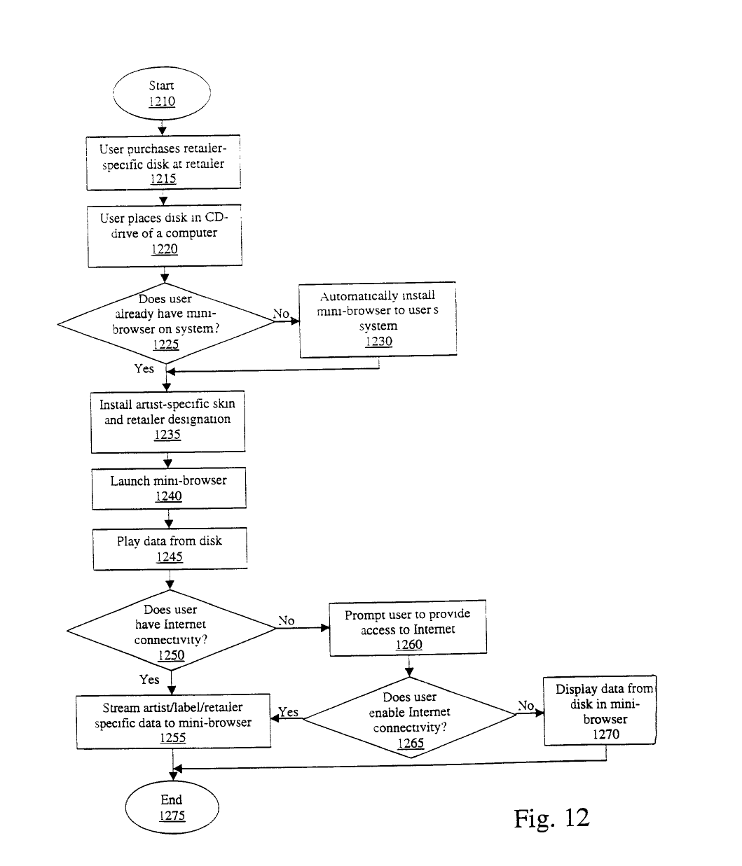

FIG. 12 is a flowchart of one embodiment of using the artist/user interface from a user's perspective. At block 1215, the user purchases a retailer specific disk at a retailer. The disks distributed to different retailers, for one embodiment, indicate the retailer. In this way, the retailer is given an additional benefit, by being provided access to the user, as will be described below. For one embodiment, this may be a source of revenue from the retailer. For one embodiment, the retailer specificity may be left out of the disk.

At block 1220, the user places the disk in the CD-ROM drive of a computer. For one embodiment, the disk is an audio disk, and thus can be played on a conventional compact disk player. However, the additional features described below are only available if the disk is inserted into a drive that is coupled to a processor. Although the term “compact disk” and “CD-ROM drive” are used for simplicity, it is to be understood that alternative formats may be used. For example, the music may be on a DVD, a mini-disk, or an alternative storage format. In any case, when the storage medium is inserted into a drive which is able to read and load digital data, the present invention may function as described below.

At block 1225, the process determines whether the user already has a mini-browser installed on his or her system. For one embodiment, the mini-browser may be available from multiple sources. Additionally, the user may have previously inserted another disk that includes the mini-browser.

If the user's system does not include the mini-browser, at block 1230, the mini-browser is installed on the user's system. The process then continues to block 1235. If the mini-browser is found on the user's system, the process continues directly to block 1235.

At block 1235, the artist-specific skin and retailer designation, both encoded on the disk, are installed on the user's system. For one embodiment, the mini-browser is customized, such that the skin is appropriate to the artist. For one embodiment, the skin may include authorized images of the artist, or certain logos or data associated with the artist. FIG. 14 is an exemplary mini-browser having an artist-specific skin. The retailer designation is used by the server, as will be discussed below.

At block 1240, the mini-browser, with the new skin, is launched.

If there is data available on the disk, the mini-browser may initially play that data, as indicated in block 1245.

At block 1250, the system determines whether the user has Internet connectivity. Internet connectivity may be provided by a modem, DSL, ISDN, or another method. If Internet connectivity is found, the process continues to block 1255.

At block 1255, artist/label/retailer specific data is streamed to the mini-browser. For one embodiment, the data is derived from the artist's web site, or the label site. For one embodiment, the data presented to the user is approved by the artist and label. Thus, whether or not it is derivative data, it is authorized data. The retailer specificity consists of linking to an on-line store associated with the retailer if the user indicates within the mini-browser that he or she wishes to purchase an album. For one embodiment, the retailer to whom the disk is specific need not be the retailer from whom the user purchased the disk.

The user may interact with the data being streamed. For example, the user may access artist/label/retailer approved free content, such as music, images, or video, download music or other data, or purchase items from the retailer or directly from the artist/label.

The process then ends at block 1275. Note that although the term “streaming” is used, this is to designate that the data sent to the user is periodically updated. This does not indicate a type of data transfer. Rather, the data may be sent to the user in packets, streamed, or transferred using an alternative mechanism.

If no Internet connectivity was found at block 1250, the process continues to block 1260. At block 1260, the user is prompted to provide access to the Internet. For one embodiment, this prompt indicates to the user that additional relevant/interesting data may be available if the user opens a connection to the Internet.

At block 1265, the process determines whether the user enabled Internet connectivity. If the user enabled Internet connectivity, the process continues to block 1255, and data is send to the user's mini-browser, as described above.

If the user does not enable Internet connectivity, the process continues to block 1270. At block 1270, the process acquires data from the disk, and displays any such available data to the user in the mini-browser. For one embodiment, the purpose of this is to provide the user with a streaming-like experience, to induce the user to provide Internet connectivity. For one embodiment, the notice indicating that additional information may be available if the user provides an Internet connection may be maintained on the browser. The process then ends at block 1275.

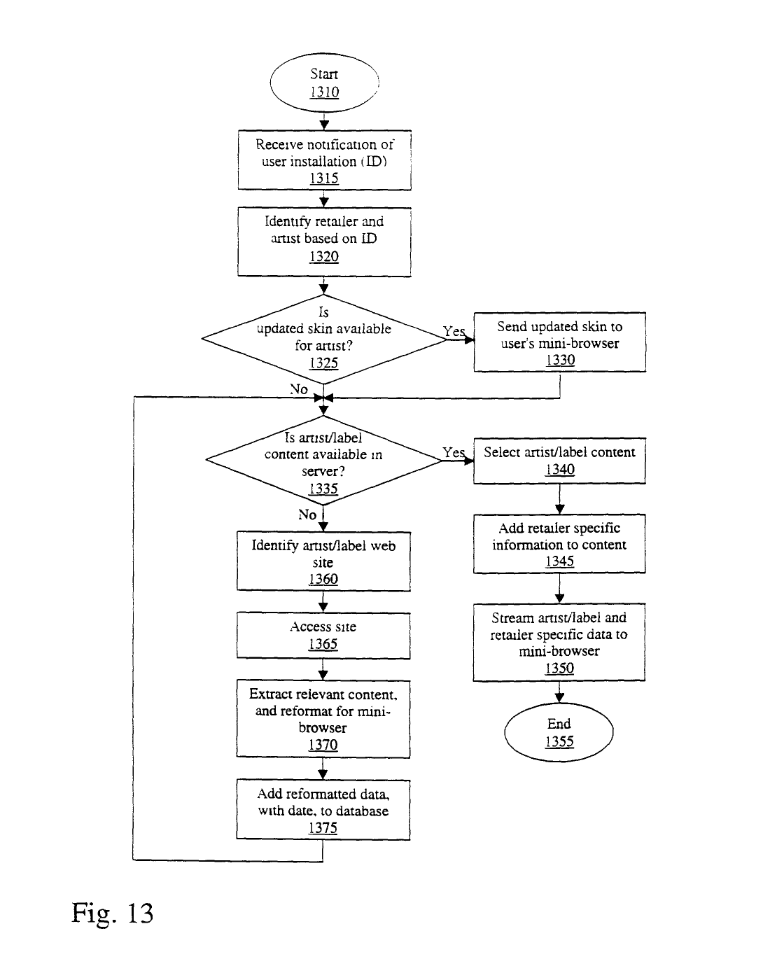

FIG. 13 is a flowchart of one embodiment of using the artist/user interface from the server's perspective. The process starts at block 1310. At block 1315, notification of the user installation is received, including a notification ID. The notification ID includes the identification provided on the disk, identifying the album, artist, and retailer. For one embodiment, the ID does not identify the user himself or herself, but rather maintains user privacy. In that instance, the server connects to the user by detecting an originating IP address for the connection, and responding to the same IP address, as was described above.

At block 1320, the retailer and artist/label are identified based on the ID.

At block 1325, the process determines whether there is an updated skin available for the particular artist or album. For one embodiment, a skin is stored on the disk, when the disk is initially shipped. However, over time, such skins may be changed. Thus, at this point, the process determines whether there is an updated skin. If there is an updated skin, the process continues to block 1330, and the updated skin is sent to the user. For one embodiment, the user is notified that there is an updated skin available, and may choose to install the updated skin or refuse to install the updated skin. The process then continues to block 1335.

At block 1335, the process determines whether there is artist/label content available in the database of the server. If there is content available, the process continues to block 1340, otherwise the process continues to block 1360.

At block 1340, the artist/label content is selected, and at block 1345, retailer specific data is added to the content. For one embodiment, part of the content presented to the user is information about the other records available from the same artist. If the user wishes to purchase an album, he or she may do so through the mini-browser, as was discussed above. Retailer specificity indicates the URL to which such a purchase request should be sent.

At block 1350, the content is sent to the mini-browser. For one embodiment, this may be done as a block-transaction sending all of the data available at once, and having the mini-browser display the data sequentially. For another embodiment, this process may be repeated, and one page at a time may be sent to the user. Solutions between these two extremes may also be implemented. The process then ends at block 1355.

If no artist/label content was found, at block 1335, the process continues to block 1360.

At block 1360, the artist/label web site is identified. For one embodiment, in a database, there is a listing of each artist participating in this linking system, and the appropriate web site/source for artist information.

At block 1365, the site is accessed, and relevant content is extracted, at block 1370. Relevant content may include all video and images provided by the artist, any songs provided, any concert dates listed, any essays or question & answers, and similar data. For one embodiment, the data is examined, and anything that is not an advertisement is deemed relevant. The process then reformats the data, in an appropriate format for the mini-browser, also at block 1370. Because of the limited size of the mini-browser display, the data should be reformatted to present optimally to the user. For one embodiment, photos may also be formatted into a photo montage, or similar mechanism. Furthermore, at this point, data may be reformatted into a different format (from GIF to jpeg, or the like.)

At block 1375, the reformatted data is added to the database with a date. For one embodiment, the server periodically seeks to update artist/label content, even if data is available within the server. For one embodiment, this date added to the downloaded content is used. For one embodiment, if the data is beyond a certain age it is discarded, or reviewed, and new data is acquired from the artist's web site. The process then returns to block 1335, to find that artist/label content is available.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of providing a link between a fan and an artist, the method comprising:
when the user inserts a disk in a CD-ROM drive, uploading a mini-browser having an artist-specific skin; and
presenting web content from the artist in the mini-browser.
